(19) United States
(12) Patent Application Publication
(10) Pub. No.: US 2021/0078431 A1
(43) Pub. Date: Mar. 18, 2021

(54) CHARGE CONTROL DEVICE, TRANSPORTATION DEVICE, AND COMPUTER READABLE STORAGE MEDIUM

(71) Applicant: HONDA MOTOR CO.,LTD., Tokyo (JP)

(72) Inventors: Yuka NAGATOCHI, Saitama (JP); Takeshi FUJINO, Saitama (JP)

(21) Appl. No.: 17/106,177

(22) Filed: Nov. 29, 2020

Related U.S. Application Data
(63) Continuation of application No. PCT/JP2019/010847, filed on Mar. 15, 2019.

(30) Foreign Application Priority Data
May 31, 2018 (JP) 2018-104944

(51) Int. Cl. B60L 53/62; H02J 7/00; B60L 58/12

(52) U.S. Cl. CPC B60L 53/62; H02J 7/0048; H02J 7/007194; B60L 2240/545; H02J 7/00714; H02J 7/0013; B60L 58/12; H02J 7/007182

(57) ABSTRACT

A charge control device includes a storage unit for storing a plurality of pieces of charging information, each specifying a charging limit value using a temperature and a voltage of a battery as an indicator, and selection information for selecting one piece of charging information from the plurality of pieces of charging information based on the temperature and voltage of the battery, an acquisition unit for acquiring a temperature and a charge amount of the battery, a selection unit for selecting one piece of charging information from the plurality of pieces of charging information based on the temperature and charge amount of the battery acquired by the acquisition unit and the selection information, and a charge control unit for controlling charging of the battery using the temperature and charge amount of the battery acquired by the acquisition unit and the one piece of charging information selected by the selection unit.

### CROSS REFERENCE TO RELATED APPLICATION

The contents of the following Japanese patent application and internal application are incorporated herein by reference,

Japanese Patent Application No. 2018-104944 filed on May 31, 2018 and

International Application No. PCT/JP2019/010847 filed on Mar. 15, 2019.

### BACKGROUND

### 1. Technical Field

The present invention relates to a charge control device, a transportation device, and a computer readable storage medium.

### 2. Related Art

As a charging method of a secondary battery, a constant current constant voltage method or the like is known (see, for example, the following patent literatures).

### CITATION LIST

### Patent Literatures

### Patent Literature 1: WO2016/113791

### Patent Literature 2: Japanese Patent Application Publication No. 2008-253129

Patent Literature 3: Japanese Patent Application Publication No. Hei 8-106921

### BRIEF DESCRIPTION OF THE DRAWINGS

FIG. 1 schematically illustrates a configuration of a charging system 5 of an embodiment.

FIG. 2 schematically illustrates a functional configuration of a charging ECU 40.

FIG. 3 illustrates an example of a charging power map in the form of table.

FIG. 4 illustrates an example of a charging current map in the form of table.

FIG. 5 illustrates a map selected by a map-selection map, on a cell voltage-temperature plane.

FIG. 6 illustrates changes in charging power and charging current, which are determined by a charge control unit 200, on the charging power map and the charging current map, respectively.

FIG. 7 schematically illustrates the time evolution of a cell voltage under charge control of the charging ECU 40.

FIG. 8 schematically illustrates the time evolution of a battery temperature under the charge control of the charging ECU 40.

FIG. 9 schematically illustrates the SOC-voltage chart indicative of the correspondence between OCV and the cell voltage.

FIG. 10 is a flowchart illustrating processing performed by the charging ECU 40 when charging a vehicle 10.

FIG. 11 schematically illustrates an example of a computer 1000 functioning as the charging ECU 40.

### DESCRIPTION OF EXEMPLARY EMBODIMENTS

Hereinafter, embodiments of the present invention will be described. The following embodiments do not limit the invention according to the claims. All the combinations of the features described in the embodiments are not necessarily essential to means provided by aspects of the invention.

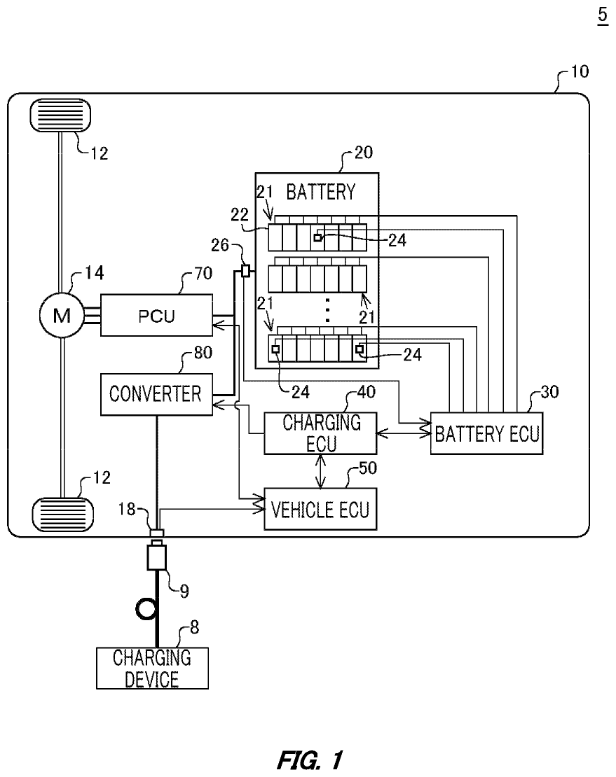

FIG. 1 schematically illustrates a configuration of a charging system 5 of an embodiment. The charging system 5 includes a charging device 8 and a vehicle 10. The vehicle 10 is an example of a transportation device. The vehicle 10 is, for example, an electric vehicle. Examples of the electric vehicle include a battery electric vehicle (BEV) and a plug-in hybrid electric vehicle (PHEV). The vehicle 10 may be a hybrid vehicle equipped with an internal combustion engine that provides at least part of the power.

The vehicle 10 includes drive wheels 12, a motor unit 14, a battery 20, a battery ECU 30, a charging ECU 40, a vehicle ECU 50, a PCU 70, and a converter 80. ECU is an abbreviation for Electronic Control Unit. PCU is an abbreviation for Power Control Unit.

The battery 20 stores electrical energy. The electrical energy stored in the battery 20 is supplied to the PCU 70 as DC power. The PCU 70 converts the DC power from the battery 20 to AC power and supplies the motor unit 14 with the AC power. The motor unit 14 outputs power by using the AC power supplied from the battery 20. The power of the motor unit 14 is transmitted to the drive wheels 12. The motor unit 14 converts kinetic energy of the vehicle 10 transmitted through the drive wheels 12 and the like into electrical energy to generate regenerative power. The PCU 70 converts the generated regenerative power into DC power and stores the DC power in the battery 20.

The converter 80 converts AC power supplied from the charging device 8 through a power receiver 18 included in the vehicle 10 to DC power and supplies the battery 20 with the DC power. The battery 20 is provided with a current sensor 26. The current sensor 26 detects a current supplied to the battery 20. The current sensor 26 detects the power supplied from the converter 80 to the battery 20. The current sensor 26 also detects a current supplied from the battery 20 to the PCU 70. A signal indicative of a current value detected by the current sensor 26 is supplied to the battery ECU 30.

The battery 20 is provided with a plurality of assembled batteries 21 connected in series and a plurality of temperature sensors 24 including a temperature sensor 24a, a temperature sensor 24b and a temperature sensor 24c. The assembled batteries 21 each include a plurality of cells 22 connected in series. The cells 22 may constitute a lithium-ion battery, a nickel-metal hydride battery, or the like. The temperature sensors 24 each detect the temperature of the inside of the battery 20. The temperature sensors 24 are provided in a plurality of positions inside the battery 20 so as to detect the temperature of a high-temperature portion and the temperature of a low-temperature portion inside the battery 20. A signal indicative of the temperature detected by the temperature sensor 24 is supplied to the battery ECU 30.

The battery 20 supplies the battery ECU 30 with a signal indicative of a cell voltage of each of the plurality of cells 22 detected by a voltage sensor. For example, when the battery 20 has M cells 22, the battery 20 supplies the battery ECU 30 with signals indicative of M cell voltages. The cell voltage is measured as a voltage between an anode and a cathode of a corresponding cell.

The battery ECU 30 outputs various signals by monitoring the state of the battery 20. For example, the battery ECU 30 calculates various state quantities, such as SOC and internal resistance of each cell 22, based on various signals, such as the cell voltage signal supplied from the battery 20, the current signal supplied from the current sensor 26, and the temperature signal supplied from a temperature sensor 24. SOC is an abbreviation for State of Charge. The battery ECU 30 supplies the vehicle ECU 50 and the charging ECU 40 with various state quantities calculated.

The vehicle ECU 50 controls the PCU 70 based on information supplied from the charging ECU 40, the battery ECU 30 and the PCU 70. When detecting the insertion of a charging connector 9 of the charging device 8 into the power receiver 18, the vehicle ECU 50 acquires identification information of the charging device 8 from the charging device 8. In a case where the battery 20 can be charged by the charging device 8, the vehicle ECU 50 supplies the charging ECU 40 with charging permission information indicating that the battery is chargeable and a required value of the SOC. The charging ECU 40 controls the converter 80 based on information supplied from the battery ECU 30 and the vehicle ECU 50, thereby causing the battery 20 to be charged.

The charging ECU 40 stores a charging power map that maps the temperature and cell voltage of the battery 20 to a charging power of constant power charging, a charging current map that maps the temperature and cell voltage of the battery 20 to a charging current of constant current charging, and a map-selection map that maps the temperature and cell voltage of the battery 20 to either the charging current map or the charging power map. The charging ECU 40 selects one of the charging power map and the charging current map based on the temperature and cell voltage of the battery 20 acquired from the battery ECU 30 and the map-selection map. The charging ECU 40 charges the battery 20 using the selected map and the temperature and cell voltage of the battery 20 acquired from the battery ECU 30.

For example, the map-selection map is set so as to select the charging power map in a case where the cell voltage is lower than a predetermined voltage or the temperature of the battery 20 is lower than a predetermined temperature, and to select the charging current map in a case where the voltage of the battery 20 is greater than or equal to the predetermined voltage or the temperature of the battery 20 is higher than or equal to the predetermined temperature. Therefore, the charging ECU 40 starts charging by the constant power charging based on the charging power map when the temperature and cell voltage of the battery 20 are relatively low at the start of charging. When the charging of the battery 20 proceeds, causing the temperature and cell voltage of the battery 20 to increase, the charging ECU 40 switches to the constant current charging based on the charging current map. Thereafter, when the cell voltage of the battery 20 reaches a target voltage, the constant voltage charging is performed for a certain period of time, and then this charging of the battery 20 is ended.

When the cell voltage is relatively low, that is, when the SOC is relatively low, the cells 22 do not deteriorate so much due to the charging. In such a case, by charging with the power specified by the charging power map, the battery is charged at a relatively large current while suppressing its deterioration, thus making it possible to shorten the charging time. When the cell voltage increases due to charging, i.e., when the SOC becomes comparatively high, the battery 20 is charged while suppressing its deterioration by switching to the constant current charging in accordance with the charging current map, and switching the charging current in stages. Then, when the voltage of the battery 20 reaches a target voltage, the constant voltage charging is performed. When the cell voltage is relatively high, that is, when the SOC is relatively high, the cells 22 are apt to deteriorate due to the charging. In this case, by charging the battery at the current specified in the charging current map, for example, the charging can be performed while suppressing anode deterioration, such as lithium electrocrystallization and a structural change of an active material in a lithium-ion battery. This can significantly shorten the time for the constant voltage charging after the target voltage is reached while suppressing the deterioration of the cells 22, for example, compared to fast charging by Constant Current Constant Voltage (CCCV) charging. Thus, the total charging time can be shortened.

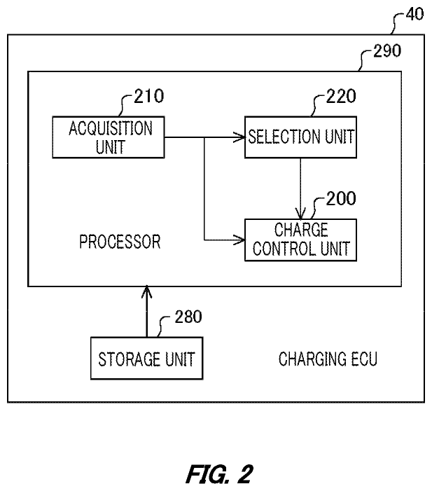

FIG. 2 schematically illustrates a functional configuration of the charging ECU 40. The charging ECU 40 includes a processor 290 and a storage unit 280. The processor 290 includes an acquisition unit 210, a selection unit 220, and a charge control unit 200.

The processor 290 may be a processing device, such as a microprocessor. The charging ECU 40 is a kind of computer. The storage unit 280 stores information necessary for the operation of the charging ECU 40. The storage unit 280 stores a control program for the charging ECU 40, constants and variables used by the control program, and temporary information necessary for computation of the control program.

The acquisition unit 210 acquires information supplied from the battery ECU 30, information supplied from the vehicle ECU 50, and information supplied from the converter 80. The acquisition unit 210 acquires, from the battery ECU 30, the information indicative of the voltage, SOC, temperature, internal resistance, and maximum permitted current of the battery 20. The acquisition unit 210 also acquires the charging permission information supplied from the vehicle ECU 50 and information indicative of a required value of SOC. The charging permission information and the information indicative of the required value of SOC are supplied from the vehicle ECU 50 to the charging ECU 40 when the charging connector 9 is connected to the power receiver 18 and the vehicle ECU 50 determines, based on the identification information acquired from the charging device 8, that the vehicle 10 can be charged by the charging device 8.

The charge control unit 200 controls the charging of the battery 20. For example, the charge control unit 200 controls fast charging of the battery 20. The charge control unit 200 controls the converter 80 to thereby control the power supplied from the charging device 8 to the battery 20.

The storage unit 280 stores the charging power map that specifies the charging power using the temperature and voltage of the battery 20 as an indicator, the charging current map that specifies the charging current using the temperature and voltage of the battery 20 as the indicator, and the map-selection map for selecting information for use in charging of the battery 20 from the charging power map and the charging current map based on the temperature and voltage of the battery 20. The charging power map is an example of charging power information that specifies the charging power using the temperature and voltage of the battery 20 as the indicator. The charging power map is an example of charging current information that specifies the charging current using the temperature and voltage of the battery 20 as the indicator.

The selection unit 220 selects one of the charging power map and the charging current map based on the temperature and voltage of the battery 20 acquired by the acquisition unit 210 and the map-selection map. The charge control unit 200 controls the charging of the battery 20 using the temperature and voltage of the battery 20 acquired by the acquisition unit 210 and the information selected by the selection unit 220. Thus, whether the battery is charged by referring to the charging power map or the battery is charged by referring to the charging current map is determined based on the map-selection map to charge the battery 20, thereby making it possible to select a charging method suitable for the state of the battery 20 at each time during charging.

When the charging power map is selected by the selection unit 220, the charge control unit 200 causes the battery 20 to be charged with the charging power specified based on the temperature and voltage of the battery 20 acquired by the acquisition unit 210 and the charging power map. The acquisition unit 210 acquires the temperature and voltage of the battery 20, when the battery 20 is charged with the charging power specified based on the temperature and voltage of the battery 20 and the charging power map. When the charging current map is selected by the selection unit 220 based on the temperature and voltage of the battery 20 acquired by the acquisition unit 210 and the map-selection map, the charge control unit 200 causes the battery 20 to be charged by switching from the charging using the charging power map to charging using the charging current map.

For example, the map-selection map associates the temperature of the battery 20 to a switching voltage that is a threshold for switching from charging using the charging power map to charging using the charging current map. For example, the map-selection map associates a higher switching voltage with a lower temperature in a range of temperatures higher than or equal to a predetermined temperature. The map-selection map may associate a lower switching voltage with a lower temperature in a range of temperatures lower than the predetermined temperature. Thus, when the temperature of the battery is in a range of temperatures on the higher temperature side, the lower temperature is associated with the higher switching voltage. On the other hand, when the temperature of the battery is in a range of temperatures on the lower temperature side, the lower switching voltage is associated with the lower temperature. For example, 0° C. or the like can be applied as the predetermined temperature. When the cells 22 constitute a lithium-ion battery, the lower the temperature of the battery 20, the lower the capacity of the battery can become due to the lithium electrocrystallization in charging. Therefore, by switching to the charging current map at a lower temperature using the map-selection map, the charging current may be limited in accordance with the charging current map to perform the charging. Thus, the battery can be charged by limiting the amount of movement of lithium ions, thereby suppressing the deterioration of the battery. The selection unit 220 selects the charging current map as the information for use in the charging of the battery 20 when the voltage of the battery 20 reaches the switching voltage associated with the temperature of the battery 20 by the map-selection map. This makes it possible to control charging such that in the low-voltage range where the cell 22 does not deteriorate much due to charging, the battery can be charged by a larger current as its voltage becomes lower, and also to control charging such that in the high-voltage range where the cell 22 is apt to deteriorate due to charging, the charging by a large current can be suppressed. Thus, the total charging time can be shortened while suppressing the deterioration of the cells 22.

After switching to the charging of the battery 20 using the charging current map, the charge control unit 200 causes the battery 20 to be charged by switching from the charging using the charging current map to constant voltage charging when the voltage of the battery 20 is greater than or equal to the target voltage. Thus, in the high-voltage range where the influence of the deterioration due to the charging becomes significant, the battery 20 can be completely charged up to the target voltage while being protected.

It is noted that the voltage of the battery 20 in which the charging power is specified by the charging power map may be a cell voltage. Similarly, the voltage of the battery 20 in which the charging current is specified by the charging current map may be a cell voltage. The voltage of the battery 20 that specifies the map using the map-selection map may be a cell voltage. As the cell voltage in this case, a cell voltage of any cell 22 included in the battery 20 may be used. The cell voltages of a plurality of cells 22 included in the battery 20 may be used as the cell voltage. For example, the acquisition unit 210 acquires the temperature of the battery 20 and the cell voltage of each of the plurality of cells included in the battery 20. Then, the selection unit 220 selects one of the charging power map and the charging current map based on the temperature of the battery 20 and the cell voltage, which are acquired by the acquisition unit 210, and the map-selection map. When the charging current map is selected by the selection unit 220 based on the temperature of the battery 20, the cell voltage of at least one cell 22, and the map-selection map, the charge control unit 200 switches to charging using the charging current map and then causes the battery 20 to be charged. This enables switching to the charging current map to charge the battery when the state of one cell 22 becomes appropriate to perform the charging in accordance with the charging current map, thereby suppressing the progress of deterioration of a particular cell 22.

As described above, the charging ECU 40 can appropriately switch between the charging power map and the charging current map depending on the state of the battery 20 to perform charging. Thus, the charging can be controlled such that the time required for fast charging of the battery 20 can be shortened while suppressing the deterioration of the cells 22.

It is noted that each of the charging power map and the charging current map is an example of a plurality of pieces of charging information, each specifying a charging limit value using the temperature and voltage of the battery 20 as the indicator, whereas the map-selection map is an example of selection information for selecting one piece of charging information from the plurality of pieces of charging information based on the temperature and voltage of the battery 20. The selection unit 220 may select one piece of charging information from the plurality of pieces of charging information based on the temperature and charge amount of the battery 20 acquired by the acquisition unit 210 and the selection information. The charge control unit 200 may control the charging of the battery 20 using the temperature and charge amount of the battery 20 acquired by the acquisition unit 210 and the information selected by the selection unit 220. For example, the plurality of pieces of charging information may include a first charging power map and a second charging power map. In this case, the selection unit 220 may select one charging power map from the first charging power map and the second charging power map based on the temperature and voltage of the battery 20 and the selection information. When the plurality of pieces of charging information include a first charging current map and a second charging current map, the selection unit 220 may select one charging current map from the first charging current map and the second charging current map based on the temperature and voltage of the battery 20 and the selection information. The charging information may specify various kinds of charging limit values, such as a charging voltage value, in addition to a charging power value and a charging current value.

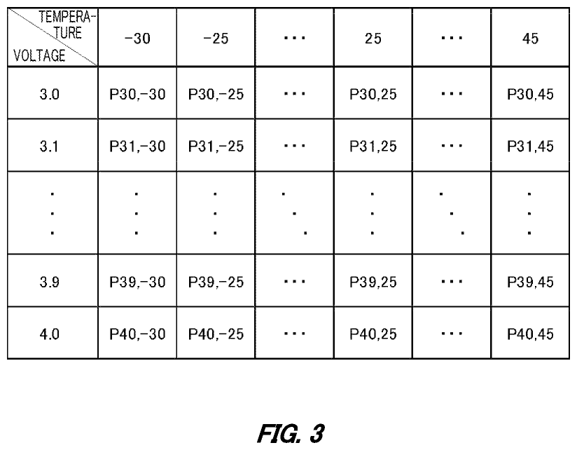

FIG. 3 illustrates an example of the charging power map in the form of table. When a cell voltage and a temperature are given, one charging power P is specified by the charging power map. In the permitted power map, the charging power is set such that the maximum current that can flow through the battery 20 is not exceeded.

The charge control unit 200 determines the charging power P specified by the temperature and cell voltage of the battery 20 supplied from the battery ECU 30 by referring to the charging power map. For example, according to the charging power map shown in FIG. 3, the charge control unit 200 determines the charging power to be P30, 25 when the temperature of the battery 20 is higher than or equal to 25° C. and lower than 30° C., while the cell voltage is greater than or equal to 3.0 V and less than 3.1 V. The charge control unit 200 charges the battery 20 with constant power, which is the determined charging power P.

The charge control unit 200 may use the maximum value T1 of the temperature detected by the temperature sensor 24, as the temperature of the battery 20 to be used to determine the charging power from the charging power map. The charge control unit 200 may determine the charging power P specified by T1 and the cell voltage in the charging power map for each of the plurality of cells 22. In this case, the charge control unit 200 may determine the minimum power of the charging powers P determined from T1 and the cell voltages of the respective plurality of cells 22, as the charging power of the battery 20.

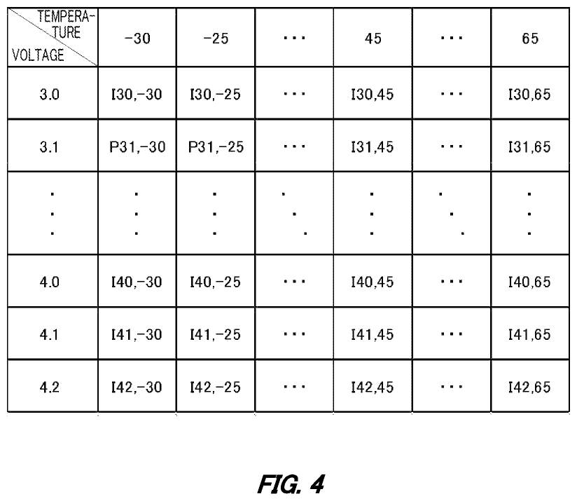

FIG. 4 illustrates an example of the charging current map in the form of table. When a cell voltage and a temperature are given, one charging current I is specified by the charging current map. In the charging current map, the charging current I is set such that the deterioration of the battery 20 can be suppressed, for example, when the battery 20 is charged in a high SOC region. For the cells 22 constituting the lithium-ion battery, for example, the charging current I is set such that anode deterioration, such as Li electrocrystallization and a structural change of an active material, can be suppressed. The charging current I is set such that the charging current or the amount of generated heat does not become excessive, in consideration of the temperature of the battery 20 and changes in the internal resistance of the cell 22 in accordance with the temperature of the battery 20.

The charge control unit 200 determines the charging current I specified by the temperature and cell voltage of the battery 20 supplied from the battery ECU 30 by referring to the charging current map. For example, according to the charging current map shown in FIG. 4, the charge control unit 200 determines the charging current to be 140, 45 when the temperature of the battery 20 is higher than or equal to 45° C. and lower than 50° C., and the cell voltage is greater than or equal to 4.0 V and less than 4.1 V. The charge control unit 200 charges the battery 20 with constant current, which is the determined charging current I.

The charge control unit 200 may use the maximum value T1 of the temperature detected by the temperature sensor 24, as the temperature of the battery 20 used to determine the charging current from the charging current map. The charge control unit 200 may determine the charging current I specified by T1 and the cell voltage in the charging current map for each of the plurality of cells 22. In this case, the charge control unit 200 may determine the minimum current of the charging current I determined from the cell voltage and T1 of each of the plurality of cells 22, as the charging current of the battery 20.

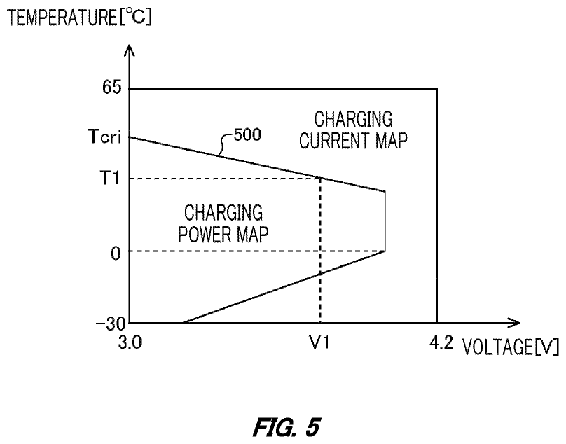

FIG. 5 illustrates a map selected by the map-selection map, on a cell voltage-temperature plane. Then, one of the charging power map and the charging current map is specified by the map-selection map when the temperature and cell voltage of the battery 20 are given. The map-selection map defines a boundary line 500 which is a boundary between the charging power map and the charging current map on the cell voltage-temperature plane. In a range of temperatures higher than or equal to 0° C., the charging power map is positioned on the lower temperature side with respect to the boundary line 500 or on the lower voltage side with respect to the boundary line 500, on the cell voltage-temperature plane. In the range of temperatures higher than or equal to 0° C., the charging current map is positioned on the higher temperature side with respect to the boundary line 500 or on the higher voltage side with respect to the boundary line 500, on the cell voltage-temperature plane. In a range of temperatures lower than 0° C., the charging power map is positioned on the higher temperature side with respect to the boundary line 500 or on the lower voltage side with respect to the boundary line 500, on the cell voltage-temperature plane. In the range of temperatures lower than 0° C., the charging current map is positioned on the lower temperature side with respect to the boundary line 500 or on the higher voltage side with respect to the boundary line 500, on the cell voltage-temperature plane.

Tcri is an upper limit temperature to which the charging power map is applicable. Whenever the temperature of the battery 20 is higher than or equal to Tcri, the charging current map is definitely applied.

Referring to the map-selection map, the selection unit 220 specifies, as the switching voltage V1, a cell voltage shown at the coordinates on the boundary line 500 corresponding to T1 by using the maximum value T1 of the temperature detected by the temperature sensor 24. For example, the selection unit 220 selects the charging power map in a case where there is no cell voltage exceeding the switching voltage V1 among the cell voltages of the plurality of cells 22, and selects the charging current map in a case where there is at least one cell voltage exceeding the switching voltage V1 among them. When one of the charging current map and the charging power map is selected by the selection unit 220, the charge control unit 200 determines the charging power or charging current in accordance with the charging power map illustrated in FIG. 3 or the charging current map illustrated in FIG. 4.

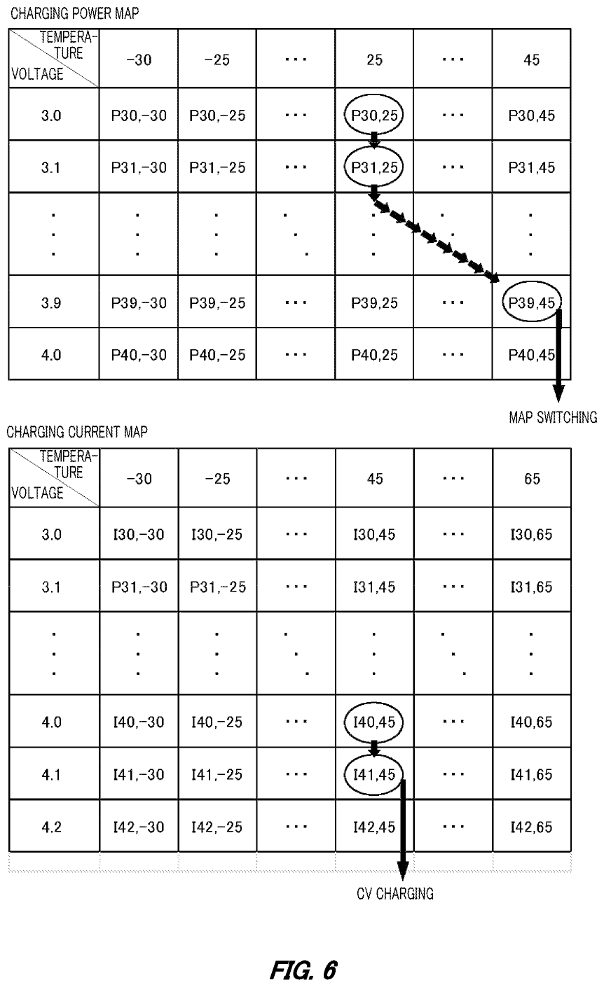

FIG. 6 illustrates changes in charging power and charging current, which are determined by the charge control unit 200, on the charging power map and the charging current map. At the start of charging, the charge control unit 200 refers to the charging power map selected based on the cell voltage and the temperature at the start of the charging, and determines the charging power to be P30, 25 from these cell voltage and temperature. The charge control unit 200 starts the constant power charging at P30, 25. The charge control unit 200 switches to the constant power charging at P31, 25 when the cell voltage reaches 3.1 V in a state where T1 being in a range of 25° C. or higher and lower than 30° C. during the constant power charging at the P30, 25. The charge control unit 200 sequentially switches the charging power by referring to the charging power map, in accordance with the temperature and cell voltage supplied from the battery ECU 30.

The selection unit 220 selects the charging current map when the cell voltage of at least one cell 22 is greater than or equal to the switching voltage V1 corresponding to T1 during the constant power charging at P39, 45. The charge control unit 200 switches the map to be referred to, from the charging power map to the charging current map and thereby switches the charging method to the constant current charging at 140, 45. The charge control unit 200 sequentially switches the charging current by referring to the charging current map, in accordance with the temperature and cell voltage supplied from the battery ECU 30.

The charge control unit 200 switches to the constant voltage charging when the cell voltage reaches the target voltage of 4.2 V during the constant current charging at 141, 45. The charge control unit 200 causes the constant voltage charging to be performed for 30 minutes at a charging voltage, which is applied at the time of switching to the constant voltage charging, and thereafter stops charging the battery 20.

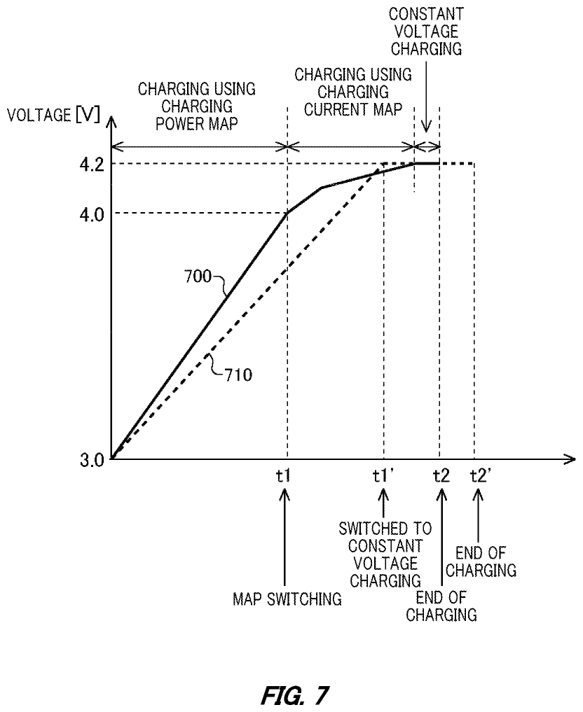

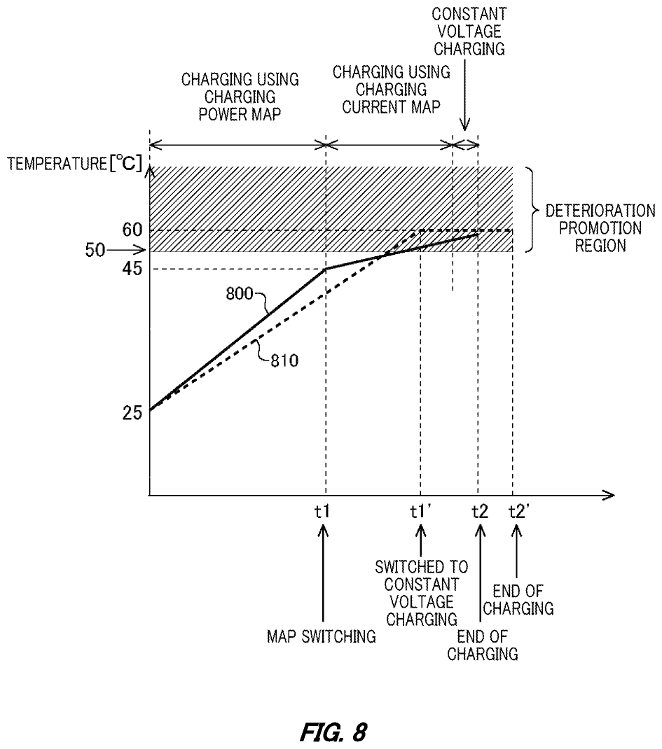

FIG. 7 schematically illustrates the time evolution of the cell voltage under the charge control of the charging ECU 40. A solid line 700 indicates the time evolution of the cell voltage under the charge control of the charging ECU 40. A dashed line 710 indicates the time evolution of the cell voltage in the case of performing CCCV charging as a comparison example. FIG. 8 schematically illustrates the time evolution of the battery temperature under the charge control of the charging ECU 40. A solid line 800 indicates the time evolution of the battery temperature under the charge control of the charging ECU 40. A dashed line 810 indicates the time evolution of the battery temperature in the case of performing CCCV charging as the comparison example.

According to the CCCV charging as the comparison example, the current charging is performed at a specific rate of, for example, about 0.7 to 1C, and at time t1′ when the cell voltage reaches a predetermined end-of-charge voltage of 4.2 V, the charging is switched to the constant voltage charging, in which the charging current is reduced to maintain the end-of-charge voltage. Eventually, the charging is ended at time t2′. As illustrated in FIG. 7, when fast charging is performed by a CCCV charging method, the end-of-charge voltage is reached at an early stage because of the constant current charging with a large amount of current, and then the charging is quickly switched to the constant voltage charging, whereby it takes longer to reach the time t2′ when the constant voltage charging ends. In addition, since the state where the temperature of the battery is high and the cell voltage is close to the specified charging voltage continues for a long time, the deterioration of the cells may be promoted. For example, the reduction in the cell capacity may progress due to the deterioration of cycle characteristics of the battery.

In contrast, as illustrated in FIGS. 7 and 8, under the charge control of the charging ECU 40, the battery is charged while switching the charging power in accordance with the charging power map when the cell voltage is low. When the cell voltage is low, i.e., when SOC is low, more electric energy can be stored in the battery 20 while suppressing the deterioration of the battery 20 because the charging is less likely to cause the deterioration of the cell 22.

When the cell 22 is brought into a state where T1 is 45° C. and the cell voltage reaches 4.0V, the charging current map is selected in accordance with the map-selection map at time t1, and thus the battery is charged while switching the charging current in accordance with the charging current map. For the battery 20 which is, for example, a lithium-ion battery, by switching the charging current in accordance with the charging current map, the battery 20 can be charged at a current value that can suppress anode deterioration, such as Li electrocrystallization and a structural change of an active material. According to the charging current map, the charging current can be switched depending on the temperature of the battery 20, thereby preventing an excess charging current from being supplied to the battery by taking into consideration changes in the internal resistance of the cell 22 due to the temperature of the battery 20. In addition, the amount of heat generated due to the charging can be prevented from becoming excessive depending on the temperature of the battery 20.

When the cell 22 is brought into a state where the cell voltage reaches 4.2 V due to the constant current charging, the charging is switched to the constant voltage charging, and then the constant voltage charging is completed in about 30 minutes. Thus, the time taken to reach the time t2 when the constant voltage charging ends can be shortened, compared to the CCCV charging.

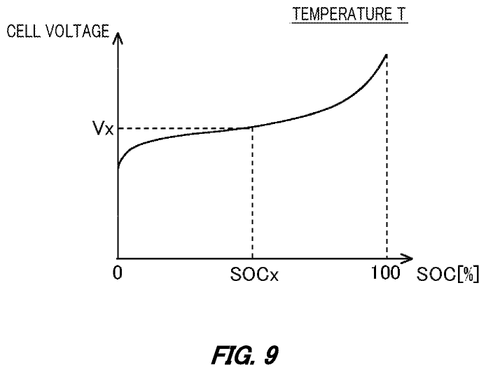

FIG. 9 schematically illustrates a SOC-voltage chart indicative of the correspondence between OCV and the cell voltage. The battery ECU 30 and the charging ECU 40 store the SOC-voltage chart that associates the cell voltage with the SOC. For example, the battery ECU 30 supplies the charging ECU 40 with the SOC of each cell 22 calculated from the cell voltage of each cell 22. For example, the battery ECU 30 calculates an SOCx which is specified by a cell voltage Vx of the cell 22 and the SOC-voltage chart, as the SOC of the cell 22. The battery ECU 30 stores an SOC map for each temperature. Thus, the charging ECU 40 calculates the SOC from the cell voltage by referring to the SOC-voltage chart corresponding to the temperature of the battery 20 detected by the temperature sensor 24.

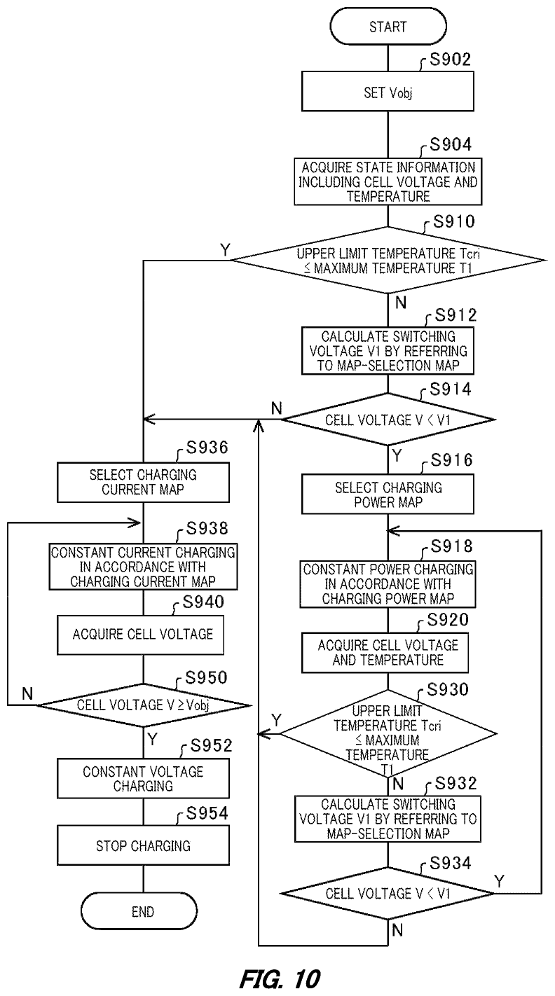

FIG. 10 is a flowchart illustrating processing performed by the charging ECU 40 when charging the vehicle 10. The processing of this flowchart is started when the charging permission information and the information indicative of the required value of the SOC are supplied from the vehicle ECU 50.

In S902, the charge control unit 200 determines an SOCobj based on the required value of the SOC acquired from the vehicle ECU 50. The SOCobj is the SOC which is the target value for charging. The charge control unit 200 calculates a target voltage Vobj corresponding to the SOCobj by referring to the above-described SOC-voltage chart.

In S904, the acquisition unit 210 acquires, from the battery ECU 30, battery information including the cell voltage and the temperature of the battery 20. The battery ECU 30 transmits the current cell voltage, current, and temperature detected in the battery 20 to the charging ECU 40 at intervals of, for example, one to ten seconds or so. At the start of charge control, the battery ECU 30 calculates the internal resistance from the detected voltage, current, and temperature. The battery ECU 30 transmits, to the charging ECU 40, an upper limit charging current based on the calculated internal resistance and the current SOC. The battery 20 is charged within a range up to the upper limit charging current.

In S910, the selection unit 220 determines whether or not the maximum temperature T1 of the battery 20 is higher than or equal to the upper limit temperature Tcri. If the maximum temperature T1 is higher than or equal to the upper limit temperature Tcri, the processing proceeds to S936. The processing after S936 will be described later. If the maximum temperature T1 is lower than the upper limit temperature Tcri, in S912, the selection unit 220 calculates a switching voltage V1 corresponding to the maximum temperature T1 by referring to the map-selection map.

In S914, the selection unit 220 determines whether or not the cell voltage V is less than V1. As the cell voltage V, the maximum value among the cell voltages of the plurality of cells 22 may be applied. If the cell voltage V is greater than or equal to V1, the process proceeds to S936. If the cell voltage V is less than V1, in S916, the selection unit 220 selects the charging power map. In S918, the charge control unit 200 causes the battery 20 to be charged with constant power by switching the charging power in accordance with the charging power map. It is noted that the constant power charging is performed within a range up to the maximum supply power of the charging device 8.

In S920, the selection unit 220 determines whether or not the maximum temperature T1 of the battery 20 is higher than or equal to the upper limit temperature Tcri when the acquisition unit 210 acquires the cell voltage and temperature of the battery transmitted from the battery ECU 30 on a regular basis. If the maximum temperature T1 is higher than or equal to the upper limit temperature Tcri, the processing proceeds to S936. If the maximum temperature T1 is lower than the upper limit temperature Tcri, in S932, the selection unit 220 calculates the switching voltage V1 by referring to the map-selection map.

In S934, the selection unit 220 determines whether or not the cell voltage V is less than V1. As the cell voltage V, the maximum value among the cell voltages of the plurality of cells 22 may be applied. If the cell voltage V is greater than or equal to V1, the process proceeds to S936. If the cell voltage V is less than V1, the process proceeds to S918. Thus, the charge control unit 200 continues the charging power in accordance with the charging power map.

In S936, the selection unit 220 selects the charging current map. In S938, the charge control unit 200 causes the battery 20 to be charged with constant current by switching the charging current in accordance with the charging current map.

When the acquisition unit 210 acquires the cell voltage transmitted from the battery ECU 30 on a regular basis in S940, the charge control unit 200 determines whether or not the cell voltage V is higher than or equal to the target voltage Vobj in S950. As the cell voltage V, the maximum value among the cell voltages of the plurality of cells 22 may be applied. If the cell voltage V is less than the target voltage Vobj, the process proceeds to S938, in which the constant current charging in accordance with the charging current map is continued. If the cell voltage V is greater than or equal to the target voltage Vobj, in S952, the charge control unit 200 switches the charging to the constant voltage charging. The charge control unit 200 continues the constant voltage charging at the charging voltage, which is applied at the time of switching to the constant voltage charging, for a predetermined period of time. The time during which the constant voltage charging is performed may be about 30 minutes. When the predetermined period of time elapses after the start of the constant voltage charging, in step S954, the charge control unit 200 stops the charging of the battery 20.

As described above, according to the control performed by the charging ECU 40 in the charging system 5, the charging in accordance with the charging power map and the charging in accordance with the charging current map can be switched depending on the state of the voltage and temperature of the battery 20 as the indicator. Thus, the charging time can be shortened while suppressing the deterioration of the battery 20 by charging the battery in accordance with the charging power map in a state with less deterioration of the battery due to the charging and by charging the battery in accordance with the charging current map in a state with significant deterioration of the battery due to the charging.

As mentioned above, the CCCV charging takes a long time to complete and also causes the deterioration of the battery to progress. When the charging current is decreased in stages at the late stage of the constant current charging in order to suppress the progress of deterioration of the battery due to the charging with a high SOC, the charging time becomes longer. The internal resistance of the battery changes depending on its temperature, which may cause overcharging or undercharging. If the end-of-charge voltage is set by adding a voltage drop caused by the internal resistance to the reference voltage, the battery becomes hot due to heat generated by the charging and thus the deterioration of the battery may be promoted.

In contrast, as mentioned above, according to the control of the charging ECU 40, the charging time can be shortened while suppressing the deterioration of the battery 20. It is noted that such an effect of shortening the charging time does not depend much on the deterioration state of the battery 20. The effect of shortening the charging time can be obtained from Beginning of Life (BOL) to End of Life (EOL) of the battery 20. For example, in BOL, the deterioration of the battery 20 does not progress and its internal resistance is low, so that the battery can be charged in accordance with the charging power map without decreasing the current value. On the other hand, in EOL, the deterioration of the battery 20 may progress to increase its internal resistance, but by setting the current relatively large in accordance with the charging power map, the temperature of the battery 20 can be increased to thereby reduce its internal resistance. Thus, according to the control of the charging ECU 40, the charging time can be shortened from the BOL to the EOL.

The correspondence between the temperature and voltage in the map-selection map and each of the charging power map and charging current map as described above, the temperature and voltage in each of the charging power map and the charging current map, and specific values of the charging power determined by the charging power map and the charging current determined by the charging current map may be set in accordance with the type, capacity, and internal design of the battery 20.

In the above explanation, a description has been given on the case of using the voltage of the battery 20 to select the map based on the map-selection map and determine the charging power based on the charging power map and the charging current based on the charging current map. However, as described in relation to FIG. 9, since there is a correspondence between the voltage and SOC of the battery, the charged state of the battery 20, such as the SOC, may be applied, instead of the voltage of the battery 20, in selecting the map or determining the charging power and the charging current. That is, the charging power map may specify the charging power using the temperature and charged state of the battery 20 as the indicator, while the charging current map may specify the charging current using the temperature and charged state of the battery 20 as the indicator. The map selection map may be an example of selection information for selecting a map to be used for charging the battery from the charging power map and the charging current map based on the temperature and charged state of the battery 20. In this case, the acquisition unit 210 may acquire the temperature and charged state of the battery 20, and the selection unit 220 may select one of the charging power map and the charging current map based on the temperature and charged state of the battery acquired from the acquisition unit 210 and the map-selection map. The charge control unit 200 may control the charging of the battery 20 using the temperature and charged state of the battery 20 acquired by the acquisition unit 210 and the map selected by the selection unit 220. Various indicators including, but not limited to the SOC and the voltage of the battery, can be used to indicate the charged state of the battery.

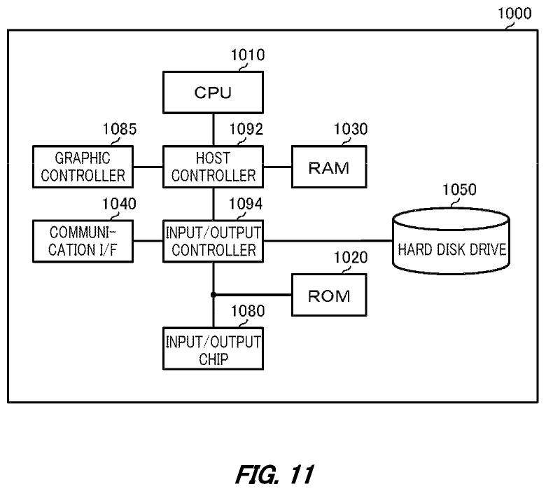

FIG. 11 schematically illustrates an example of a computer 1000 functioning as the charging ECU 40. The computer 1000 according to the present embodiment includes: a CPU peripheral unit having a CPU 1010, a RAM 1030, and a graphic controller 1085 which are interconnected by a host controller 1092; and an input/output unit having a ROM 1020, a communication I/F 1040, a hard disk drive 1050, and an input/output chip 1080, which are connected to the host controller 1092 by an input/output controller 1094.

The CPU 1010 operates based on programs stored in the ROM 1020 and RAM 1030 and controls each unit. The graphic controller 1085 acquires image data generated by the CPU 1010 and the like on a frame buffer provided in the RAM 1030, and displays the image data on a display. Instead of this, the graphic controller 1085 may contain therein the frame buffer for storing the image data generated by the CPU 1010 or the like.

The communication I/F 1040 communicates with other devices via a network by wire or wireless means. The communication I/F 1040 functions as hardware that performs communication. The hard disk drive 1050 stores programs and data to be used by the CPU 1010.

The ROM 1020 stores a boot program to be executed by the computer 1000 at startup, programs dependent on hardware of the computer 1000, and the like. The input/output chip 1080 connects various input/output devices to the input/output controller 1094 via, for example, a parallel port, a serial port, a keyboard port, a mouse port, and the like.

The program provided to the hard disk drive 1050 via the RAM 1030 is stored in a recording medium, such as an IC card, and provided by a user. The program is read from the recording medium, installed on the hard disk drive 1050 via the RAM 1030, and executed in the CPU 1010.

The program installed on the computer 1000 and causing the computer 1000 to function as the charging ECU 40 may act on the CPU 1010 or the like and may allow the computer 1000 to function as each of the units of the charging ECU 40, including the acquisition unit 210, the selection unit 220, the charge control unit 200, and the storage unit 280. The information processing described in these programs is read into the computer 1000, which functions as specific means by which the software and various hardware resources described above cooperate with each other. By these specific means, the computation or processing of the information according to the purpose of use of the computer 1000 in the present embodiment is achieved, thereby constructing the charging ECU 40 specific to the purpose of use.

While the embodiment(s) of the present invention has (have) been described, the technical scope of the invention is not limited to the above described embodiment(s). It is apparent to persons skilled in the art that various alterations and improvements can be added to the above-described embodiment(s). It is also apparent from the scope of the claims that the embodiments added with such alterations or improvements can be included in the technical scope of the invention.

It is to be noted that the operations, procedures, steps, and stages of each process performed by an apparatus, system, program, and method shown in the claims, specification, and diagrams can be performed in any order as long as the order is not indicated by “prior to,” “before,” or the like and as long as an output in a previous process is not used in a later process. Even if the operation flow is described using phrases such as “first” or “next” in the claims, specification, and diagrams for convenience, it does not necessarily mean that the processes must be performed in this order.

### EXPLANATION OF REFERENCES

5 Charging system
8 Charging device
9 Charging connector
10 Vehicle
12 Drive wheel
14 Motor unit
18 Power receiver
20 Battery
21 Assembled battery
22 Cell
24 Temperature sensor
26 Current sensor
30 Battery ECU
40 Charging ECU
50 Vehicle ECU
70 PCU
80 Converter
200 Charge control unit
210 Acquisition unit
220 Selection unit
280 Storage unit
290 Processor
500 Boundary line
700, 800 Solid line
710, 810 Dashed line
1000 Computer
1010 CPU
1020 ROM
1030 RAM
1040 Communication I/F
1050 Hard disk drive
1080 Input/Output chip
1085 Graphic controller
1092 Host controller
1094 Input/Output controller

What is claimed is:

1. A charge control device comprising:
a storage unit for storing a plurality of pieces of charging information, each specifying a charging limit value using a temperature and a voltage of a battery as an indicator, and selection information for selecting one piece of charging information from the plurality of pieces of charging information based on the temperature and voltage of the battery;
an acquisition unit for acquiring a temperature and a charge amount of the battery;
a selection unit for selecting one piece of charging information from the plurality of pieces of charging information based on the temperature and charge amount of the battery acquired by the acquisition unit and the selection information; and
a charge control unit for controlling charging of the battery using the temperature and charge amount of the battery acquired by the acquisition unit and the one piece of charging information selected by the selection unit.

2. The charge control device according to claim 1,
wherein the plurality of pieces of charging information include charging power information that specifies a charging power using a temperature and a voltage of the battery as an indicator and charging current information that specifies a charging current using a temperature and a voltage of the battery as an indicator, and
the selection unit selects one of the charging power information and the charging current information based on the temperature and voltage of the battery acquired by the acquisition unit and the selection information.

3. The charge control device according to claim 2,
wherein the charge control unit causes the battery to be charged with a charging power specified based on the temperature and voltage of the battery acquired by the acquisition unit and the charging power information when the charging power information is selected by the selection unit,
the acquisition unit acquires the temperature and voltage of the battery, when the battery is charged with the charging power specified based on the temperature and voltage of the battery and the charging power information, and
the charge control unit causes the battery to be charged by switching from charging using the charging power information to charging using the charging current information when the charging current information is selected by the selection unit based on the temperature and voltage of the battery acquired by the acquisition unit and the selection information.

4. The charge control device according to claim 3,
wherein, after switching to the charging of the battery using the charging current information, the charge control unit causes the battery to be charged by switching from the charging using the charging current information to constant voltage charging when the voltage of the battery is greater than or equal to a target voltage.

5. The charge control device according to claim 3,
wherein the acquisition unit acquires the temperature of the battery and a cell voltage of each of a plurality of cells included in the battery,
the selection unit selects one of the charging power information and the charging current information based on the temperature of the battery and the cell voltage which are acquired by the acquisition unit and the selection information, and
the charge control unit causes the battery to be charged by switching to the charging using the charging current information when the charging current information is selected by the selection unit based on the temperature of the battery, a cell voltage of at least one cell, and the selection information.

6. The charge control device according to claim 3,
wherein the selection information associates the temperature of the battery with a switching voltage, the switching voltage being a threshold for switching from the charging using the charging power information to the charging using the charging current information, and
the selection unit selects the charging current information as information for use in charging of the battery when the voltage of the battery reaches the switching voltage associated with the temperature of the battery by the selection information.

7. The charge control device according to claim 6, wherein the selection information associates a higher switching voltage with a lower temperature in a range of temperatures higher than or equal to a predetermined temperature, and associates a lower switching voltage with a lower temperature in a range of temperatures lower than the predetermined temperature.

8. The charge control device according to claim 7,
wherein the charge control unit causes the battery to be charged with a charging current specified based on the temperature and voltage of the battery acquired by the acquisition unit and the charging current information, regardless of the voltage of the battery when the temperature of the battery is higher than or equal to a predetermined upper limit temperature which is higher than the predetermined temperature.

9. A charge control device comprising:
a storage unit that stores a plurality of pieces of charging information, each specifying a charging limit value using a temperature and a charged state of a battery as an indicator, and selection information for selecting one piece of charging information from the plurality of pieces of charging information based on the temperature and charged state of the battery;
an acquisition unit that acquires a temperature and a charged state of the battery;
a selection unit that selects one piece of charging information from the plurality of pieces of charging information based on the temperature and charged state of the battery acquired by the acquisition unit and the selection information; and
a charge control unit that controls charging of the battery using the temperature and charged state of the battery acquired by the acquisition unit and the one piece of charging information selected by the selection unit.

10. A transportation device comprising the charge control device according to claim 1.

11. A transportation device comprising the charge control device according to claim 9.

12. A non-transitory computer readable storage medium storing a program, the program causing a computer to function as:
a storage unit that stores a plurality of pieces of charging information, each specifying a charging limit value using a temperature and a voltage of a battery as an indicator, and selection information for selecting one piece of charging information from the plurality of pieces of charging information based on the temperature and voltage of the battery;
an acquisition unit that acquires a temperature and a charge amount of the battery;
a selection unit that selects one piece of charging information from the plurality of pieces of charging information based on the temperature and charge amount of the battery acquired by the acquisition unit and the selection information; and
a charge control unit that controls charging of the battery using the temperature and charge amount of the battery acquired by the acquisition unit and the one piece of charging information selected by the selection unit.
